(19) United States
(12) Patent Application Publication
(10) Pub. No.: US 2026/0109320 A1
(43) Pub. Date: Apr. 23, 2026

(54) SYSTEM TO PERMIT PAIRING OF VEHICLE ACCESS DEVICE TO A VEHICLE

(71) Applicant: FCA US LLC, Auburn Hills, MI (US)

(72) Inventor: James J Hoeffel, Auburn Hills, MI (US)

(21) Appl. No.: 18/920,154

(22) Filed: Oct. 18, 2024

(51) Int. Cl. B60R 25/24; B60R 25/045; B60R 25/102; B60R 25/20

(52) U.S. Cl. CPC B60R 25/24; B60R 25/045; B60R 25/102; B60R 25/209

(57) ABSTRACT

A method for pairing a vehicle access device to a vehicle includes detecting an attempt to pair a vehicle access device with a vehicle, providing a notification to a user that an attempt to pair the vehicle access device with the vehicle has been detected, requesting an authorization from the user, receiving the authorization, and completing a pairing process. In some implementations a cool-down period may be implemented upon detecting an attempt to pair the vehicle access device with the vehicle. The cool-down period delays completion of the pairing process until either the cool-down period expires or authorization is received.

### FIELD

The present disclosure relates to a system for pairing a vehicle access device to a vehicle.

### BACKGROUND

Some vehicles include key fobs that can remotely lock or unlock the vehicle. If the key fob is lost, a service center may pair a new key fob with the vehicle. But unauthorized individuals may be able to pair a new key fob with the vehicle using similar technology to the service center to access or take the vehicle without the owner's permission.

### SUMMARY

In at least some implementations, a method for pairing a vehicle access device to a vehicle includes the steps of detecting an attempt to pair a vehicle access device with a vehicle, providing a notification to a user that an attempt to pair the vehicle access device with the vehicle has been detected, and requesting an authorization from the user before pairing the vehicle access device with the vehicle.

In at least some implementations, the method for pairing a vehicle access device to a vehicle includes the steps of receiving the authorization and completing a pairing process.

In at least some implementations, the attempt to pair the vehicle access device with the vehicle is initiated by a service device that is separate from the vehicle and from the vehicle access device.

In at least some implementations, the attempt to pair the vehicle access device with the vehicle comprises communicating a unique identifier of the vehicle access device to a vehicle control system.

In at least some implementations, the step of providing a notification to the user is accomplished by sending the notification to an external device.

In at least some implementations, the step of providing a notification to the user is accomplished by providing the notification to a vehicle control system for display via an infotainment system of the vehicle.

In at least some implementations, the vehicle control system includes a communication device capable of communicating with the external device and wherein the notification is provided from the communication device.

In at least some implementations, the notification is provided from a vehicle control system to the external device via a remote server.

In at least some implementations, the step of requesting authorization from the user includes prompting the user to input a personal identifier.

In at least some implementations, the step of receiving authorization is done after a user has successfully input a personal identifier.

In at least some implementations, completing the pairing process allows the vehicle access device and a vehicle control system to communicate to permit control of one or more vehicle functions via the vehicle access device.

In at least some implementations, the vehicle access device can perform one or more of the following vehicle functions: operating power door locks, opening windows or doors of the vehicle, disarming or triggering a vehicle alarm system, unlocking or initiating a vehicle ignition system.

In at least some implementations, a cool-down period of a predetermined length begins after the attempt to pair the vehicle access device with the vehicle is detected.

In at least some implementations, the pairing process is completed when authorization has not been received or denied, and the cool-down period has expired, or when authorization is received before the cool-down period has expired.

In at least some implementations, a system for pairing a vehicle access device to a vehicle includes a vehicle control system having a processor, memory and programming arranged to detect an attempt to pair a vehicle access device with the vehicle control system, provide a notification to a user that an attempt to pair the vehicle access device with the vehicle has been detected, and request authorization from the user to permit pairing of the vehicle access device with the vehicle control system.

In at least some implementations, the programming is arranged so that the vehicle control system must receive the authorization before the vehicle access device is paired with the vehicle control system.

In at least some implementations, the programming is arranged to request a personal identifier be provided from the user before the authorization can be provided to the vehicle control system.

In at least some implementations, the programming is arranged so that the vehicle control system must either: 1) receive the authorization before the vehicle access device is paired with the vehicle control system; or 2) allow a cool-down period of time to pass without express authorization being received or denied before the vehicle access device is paired with the vehicle control system.

In at least some implementations, completing the pairing process allows the vehicle access device and a vehicle control system to communicate and the vehicle access device can perform vehicle functions such as operating power door locks, opening windows or doors of the vehicle, disarming or triggering vehicle alarm systems, unlocking or initiating a vehicle ignition system.

In at least some implementations, the system also includes a remote server and wherein the vehicle control system sends the notification and authorization request to the remote server.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a schematic diagram of a system for pairing a vehicle access device to a vehicle;

FIG. 2 is a flow chart of a method for pairing a vehicle access device to a vehicle;

FIG. 3 is a flow chart of a method for pairing a vehicle access device to a vehicle.

### DETAILED DESCRIPTION

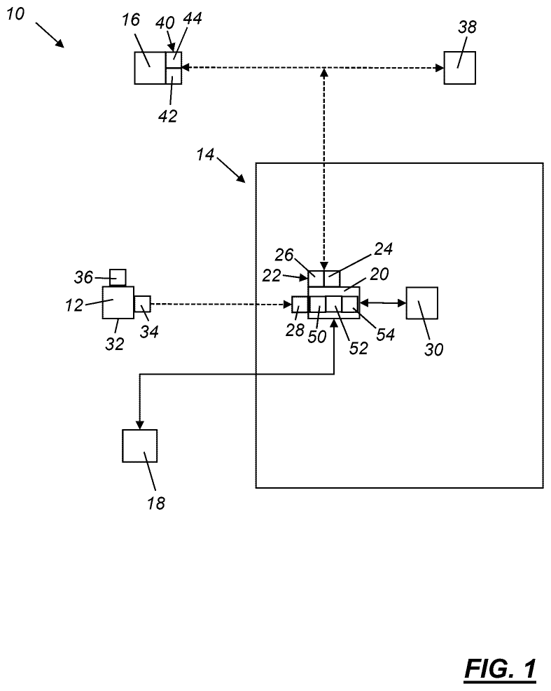

Referring in more detail to the drawings, FIG. 1 shows a system 10 for pairing a vehicle access device 12 to a vehicle 14. The vehicle access device 12 may be, by way of a non-limiting example, a so-called “key fob” or other wireless device by which door locks may be remotely operated, a vehicle ignition actuated or enabled, and other vehicle functions performed as commanded by a user. The system 10 may include the vehicle 14, the vehicle access device 12, an external device 16 by which a user can receive and respond to notifications, and a service device 18 by which the vehicle access device 12 can be paired with the vehicle 14, such as by an authorized service technician.

The vehicle 14 may have a control system 20, a communications device 22 with a transmitter 24 and a receiver 26, an access device reader 28, and a user interface 30. The vehicle transmitter 24 is capable of transmitting wireless communications and the vehicle receiver 26 is capable of receiving wireless communications. For example, wireless communications may be cellular, WiFi, satellite communications, radio, or others. The communications device 22 may be defined by separate components (e.g. for the transmitter 24 and receiver 26) or integrated into a single component depending on the embodiment.

The vehicle control system 20 is in communication with the communications device 22 such that the control system 20 can transmit and receive signals and information via the communications device 22. The control system 20 has one or more controllers or processors, memory and instructions or programs stored in the memory or otherwise accessible by the processor(s). In some implementations, the control system 20 may have or be defined by a plurality of vehicle controllers independent or networked to each other. Each of the controllers may communicate with one or more vehicle components or system components. The vehicle access reader 28 is communicated with the control system 20, and is capable of receiving a communication from the vehicle access device 12 and relaying that communication to the control system 20 to permit use of the vehicle access device 12 with the vehicle 14.

The user interface 30 may be part of a vehicle infotainment system, and may include a display visible by one or more vehicle occupants within the interior of the vehicle. The control system 20 may be in communication with the user interface 30 to provide various multimedia and information to vehicle occupants, and to provide the user interface 30 by which a user can enter information via the display or related inputs. In at least some implementations, user input via the user interface 30 may be provided through a touch-sensitive display, allowing vehicle occupant(s) to navigate through menus, adjust vehicle settings, and control features by tapping or swiping on the touchscreen. Some implementations may utilize physical controls to recognize vehicle occupant input such as button, knobs, or dials positioned within the interior of the vehicle 14. Other implementations may use voice recognition through integrated voice control systems allowing vehicle occupant(s) to operate vehicle functions using voice commands.

The vehicle access device 12 (e.g. key fob) may have a body 32 in which is housed a transmitter 34 and one or more inputs that provide a user interface 36 by which the user can input commands to be received by the vehicle access device reader 28 and recognized by the vehicle control system 20. The user interface 36 may be provided on the body 32 in the form of buttons, switches, capacitive touch, a touch screen, voice recognition, motion sensors, or other user interface, as desired. The vehicle access device 12 also includes an access device transmitter 34 that is powered by a battery and is capable of sending signals in response to one or more user inputs to the vehicle control system 20. Communication from the access device transmitter 34 can be any form of wireless communication such as, but not limited to short-range or long-range communications, such as cellular, near-field communications, Bluetooth, WiFi, satellite communications, radio, or others. When an input of the access device 12 is actuated by a user, the access device transmitter 34 sends an output to and recognizable by the vehicle control system 20. For example, actuation of a first input of the access device 12 may send an output to the control system 20 to unlock one or more vehicle doors, actuation of a second input may cause a vehicle engine to start, actuation of a third input may cause a vehicle trunk or liftgate to open, and the like.

For security and other reasons, the access device 12 communicates with only one vehicle 14 (or one vehicle 14 at a time if the access device 12 is capable of use with more than one vehicle 14). To do this, the access device 12 transmits a unique identifier along with the output commanded by actuation of one or more inputs. The unique identifier is recognized by the control system 20 which proceeds to control a vehicle system or function in response to receipt of an output command only if the unique identifier provided by the access device 12 is acceptable.

In at least some implementations, an access device 12 can be used to control one or more vehicle functions for only one specific vehicle 14, and only after the access device 12 is paired to the specific vehicle 14 and is then an approved/recognized device that is permitted to interact with the control system 20 of that vehicle 14. To facilitate pairing an access device 12 with a vehicle 14, the system 10 includes the service device 18 by which the access device 12 can be paired with the vehicle control system 20.

The service device 18 may be separate from the vehicle 14, and may be a desktop, laptop or tablet computer, of other electronic device have one or more processors, memory, and instructions or programs stored in the memory or otherwise accessible by the processors. The service device 18 contains programs that when executed by the one or more processors of the service device 18, can read, upload, delete, or edit items within the memory of the vehicle control system 20. When used for pairing the vehicle access device 12 to the vehicle 14, the service device 18 is in physical (e.g. wired to an input/port of the vehicle 14) or wireless communication with the control system 20. In at least some implementations, the service device 18 is controlled by an authorized service center or service technician who has authority or approval to pair access devices 12 with vehicles 14.

To pair a vehicle access device 12 to the vehicle 14, the service device 18 is brought into communication with the vehicle control system 20 (e.g. by wired or wireless connection) and a pairing program is executed by the one or more processors of the service device 18. The pairing program may include communicating the unique identifier of the vehicle access device 12 from the service device 18 to the vehicle control system 20. The unique identifier may be stored in the vehicle control system 20 to permit the vehicle control system 20 to recognize the access device 12 for future use.

To inhibit or prevent fraudulent pairing of an access device 12 with the vehicle control system 20, in at least some implementations, pairing or authorization for use of an access device 12 with a vehicle 14 requires acknowledgement or approval by an authorized person. In at least some implementations, the authorized person is a registered owner or registered user of the vehicle 14. In at least some implementations, before an access device 12 can be paired with the vehicle control system 20, a notification, which may be a request to pair an access device 12 with the vehicle 14, is sent to the authorized person(s) either by the vehicle control system 20 or by the service device 18 either directly or via a remote/cloud server 38, by way of non-limiting examples. In at least some implementations, user acceptance of the pairing request is required before the vehicle control system 20 (e.g. programming/memory thereof) can be updated by the service device 18 to permit use of the access device 12 with the vehicle 14.

To permit the user to receive and accept a pairing request, the notice or pairing request may be sent to the external device 16, which may be separate from the vehicle 14, or to the vehicle control system 20 for communication to the user via the user interface 30. The external device 16 may be owned or controlled by the vehicle owner/authorized user and may be a computer, smartphone, tablet or other electronic device permitting communication with and from the user. The external device 16 has one or more processors, memory, and instructions or programs stored in the memory or otherwise accessible by the processors. The external device 16 has a communication unit 40 with a device transmitter 42 capable of transmitting signals wirelessly, and a device receiver 44 capable of receiving signals wirelessly. Communication to and from the external device 16 can be any form of wireless communication such as, but not limited to cellular, WiFi, satellite communications, radio, or others. The external device 16 may include a screen capable of displaying information to a user. The one or more processors are in communication with the screen and the external device 16 may include an input system capable of obtaining user input and communicating the user input to the one or more processors. For example, a programmed user interface may be provided on the external device 16 by which a user can authorize or implement pairing of an access device 12 with the vehicle 14, for subsequent use of the access device 12 with the vehicle 14.

In at least some embodiments, the vehicle control system 20 and/or the service device 18 may communicate with the remote server 38, which may be part of a backend portion of a cloud-based system, and may include one or more processors, memory/data storage and programs to implement the functions required of the remote server 38. The remote server 38 may facilitate communication between the vehicle control system 20 or service device 18, and the external device 16. The remote server 38 is capable of receiving and transmitting communications through wireless communication such as, but not limited to, cellular, WiFi, satellite communications, radio, or others. Upon receiving communication from either the service device 18 or the vehicle 14, the remote server 38 may handle the request which may include querying local or remote memory, performing computations, or executing computer code. After handling the request, the remote server 38 formats and sends communications to the intended destination, which may include either the external device 16 or the vehicle control system 20, for action by the authorized user. The intended destination may receive the communication and, in some implementations, send an acknowledgement of receipt back to the cloud server 38.

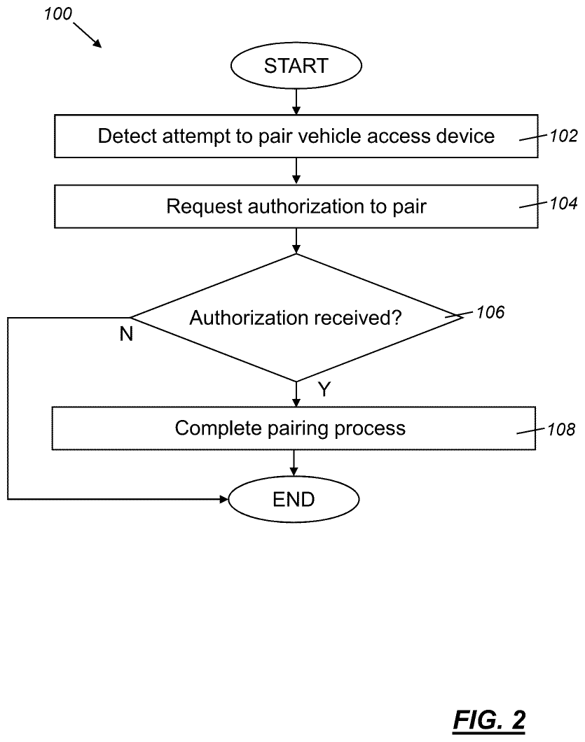

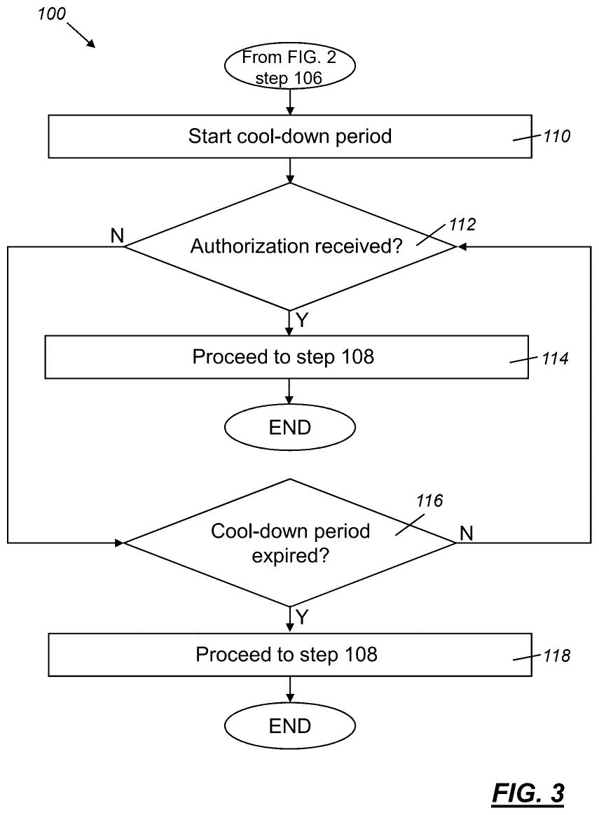

A method 100 for pairing a vehicle access device 12 to a vehicle 14 is shown in FIGS. 2-3. Referring specifically to FIG. 2, in step 102, an attempt to pair the vehicle access device 12 to the vehicle 14 is detected, which may be done by the vehicle control system 20 or initiated/done by the service device 18. In one example, this occurs when a service technician at an authorized vehicle service center attempts to pair an access device 12 with the vehicle 14 such as may be done to replace a lost or malfunctioning access device, or to add another access device 12 useable with the vehicle 14, for convenience. The attempt to pair the vehicle access device 12 to the vehicle control system 20 may be detected in multiple ways. For example, but not limited to, detecting communication between the service device 18 and the vehicle control system 20 to initiate the pairing program, detecting when the service device 18 executes the pairing program, or detecting when the control system 20 receives a request to add the unique identifier of the vehicle access device 12, by way of non-limiting examples. Upon detecting attempted pairing of the vehicle access device 12, the method 100 proceeds to step 104.

In step 104, a user is notified of the attempt to pair the vehicle access device 12 to the vehicle 14, and user authorization for the pairing operation is requested. The notice and pairing request may be sent in any desired manner, such as to the external device 16 or the vehicle control system 20 or infotainment system 30, by which the authorized person can receive and respond to the pairing request. Some vehicle manufacturers provide applications by which remote control of some vehicle functions is permitted, such as an application useable on a smartphone to remotely lock or unlock doors, start an engine, and via which information may be communicated to the vehicle user (e.g. service reminders, oil life remaining, tire pressures, informational notices and the like). The notice and pairing request can be provided via the application or other interface to permit a user to accept or deny the pairing request for the access device 12. The notification may be sent to the external device 16 directly or through the remote service by either or both of the service device 18 and the vehicle control system 20, as desired.

In step 106, it is determined whether authorization was received from the authorized user or if the pairing request was denied or not authorized. Authorization may be given by the authorized user in any desired manner, and may include identification of the authorized user to inhibit or prevent third parties from fraudulently providing the authorization. For example, the external device 16 or display may require entry of a personal identifier such as a predetermined password or pass code as authorization to pair the vehicle access device 12, security questions, temporary passwords sent to devices or generated by devices known to be owned by the owner of the vehicle 14 or authorized user of the vehicle 14, biometric authentication, geofencing, or other security measures known to those skilled in the art may be used to ensure any pairing authorization provided has come from the authorized user and not somebody else. Some embodiments may use multi-factor authentication, requiring users of the external device 16 or display of the vehicle 14 to provide two or more types of verification.

In at least some implementations, if authorization was not received, was unsuccessful, or failed for some other reason, pairing between the vehicle control system 20 and the vehicle access device 12 is prevented and the method 100 ends. This ensures that pairing the vehicle access device 12 to the vehicle 14 is only possible with the permission of the owner or the authorized user of the vehicle 14. If authorization was received, the method 100 continues to step 108.

In step 108, the pairing process of the vehicle access device 12 to the vehicle 14 is completed. After authorization is received by the vehicle control system 20 or the service device 18, the unique identifier or other data of the vehicle access device 12 is stored by the vehicle control system 20 to permit future communication between the vehicle access device 12 and the vehicle control system 20. The vehicle access device 12 may then initiate vehicle functions such as operating power door locks, opening windows or doors of the vehicle 14, disarming or triggering vehicle alarm systems, unlocking or initiating a vehicle ignition system, or others. After completing the pairing process, the service device 18 may be physically or wirelessly disconnected from the vehicle control system 20 and the method 100 may end.

As shown in FIG. 3, in at least some embodiments, when neither authorization nor a denial of authorization is received in step 106, the method 100 may proceed to step 110. In step 110, a cool-down period of a predetermined length of time is started. The cool-down period may be tracked by the vehicle control system 20 using internal time kept by the vehicle control system's 20 processor and memory. After the cool-down period timer is started, the method 100 continues to step 112.

In step 112, it is determined whether authorization has now been received from the external device 16 and/or the display. If it is determined that authorization was received, in step 114, the method 100 may return or proceed to step 108 to complete the pairing process. The vehicle access device 12 may then initiate vehicle functions such as operating power door locks, opening windows or doors of the vehicle 14, disarming or triggering vehicle alarm systems, unlocking or initiating a vehicle ignition system, among others. After completion of the pairing process, the service device 18 may be physically or wirelessly disconnected from the vehicle control system 20 and the method 100 may end.

If in step 112, if authorization or denial of authorization was not received, the method 100 continues to step 116 to determine if the cool-down period has expired. If the cool-down period has not expired, the method 100 returns to step 112 to determine whether authorization has been received and this may repeat at a predetermined interval or as necessary until either the cool-down period expires in step 116 or authorization is received in step 112. If authorization is received before the cool-down period expires, the method continues to step 114 as described above.

In step 116, if the cool-down period has expired without receiving authorization or a denial of authorization from the authorized user, the method 100, in step 118, returns to step 108 to complete the pairing process. In this embodiment, even though authorization for pairing the vehicle access device 12 was not received, the pairing operation is completed to permit use of the vehicle access device 12 with the vehicle 14.

In this embodiment, the cool-down period is intended to increase the length of time required to pair the vehicle access device 12 to the vehicle 14, deterring would be thieves from attempting to pair the vehicle access device 12 to steal the vehicle 14. By allowing the vehicle access device 12 to be paired to the vehicle 14 after the cool-down period expires, authorized service technicians may complete the pairing process even if the owner or authorized user of the vehicle is unavailable or unable to provide authorization through the external device 16 or the display. While at the same time, the cool-down period increases the time needed to pair the vehicle access device 12 and increases the likelihood of catching a thief or unauthorized user of the vehicle 14 in the act of fraudulently pairing the vehicle access device 12 with the intent to steal the vehicle 14. Of course, the method including the cool-down period is optional and user authorization may be required before any access device 12 can be paired with a vehicle 14. The option to include the cool-down period in a pairing process may be selected by the user, or by the manufacturer, for example.

Previously, thieves acquired programming sufficient to pair an access device 12 to a vehicle 14, and then entered the vehicle 14 and executed the programming to pair an access device 12 to the vehicle 14, which could be done in a relatively short period of time. This was done, for example, by connecting a laptop or other computing device to the vehicle control system via a port in the vehicle, and then executing a pairing program. When pairing was complete, the thieves could drive away with the vehicle 14. No notice was provided to the user or to a remote server 38 or other service device 18 or external device 16. Instead, the pairing happened locally between a device controlled by the thieves and the vehicle 14.

With the systems 10 and methods 100 described herein, notice is provided to a user either directly or via a remote server 38 or other device 16. The systems 10 and method 100 may require user approval of the pairing request, such as by programming that prevents the vehicle control system 20 from pairing with a vehicle access device 12 without first receiving the user authorization. In such embodiments, any attempt to pair an access device 12 with a vehicle 14 will cause the vehicle control system 20 to send the notice and pairing request to the external device 16 (directly or via a remote server 38/other devices). Thus, even if the thieves use a program that does not itself send the notice or pairing request, the notice/pairing request will be sent to the user. In some embodiments, even if express authorization is not required, some time period may be provided for the user to deny a fraudulent pairing request, which will deter thieves from attempting to pair a remote access device 12 with the vehicle 14.

To perform the functions and desired processing set forth herein, as well as the computations therefore, the control system 20 may include, but is not limited to, one or more controller(s), control unit(s), processor(s), computer(s), DSP(s), memory, storage, register(s), timing, interrupt(s) (generally referred to by reference numeral 50), communication interface(s), and input/output signal interfaces, and the like, as well as combinations comprising at least one of the foregoing. For example, the control system 20 may include input signal processing and filtering to enable accurate sampling and conversion or acquisitions of such signals from communications interfaces and sensors. As used herein the terms control system 20 may refer to one or more processing circuits such as an application specific integrated circuit (ASIC), an electronic circuit, a processor (shared, dedicated, or group) and memory 52 that executes one or more software or firmware programs 54, a combinational logic circuit, and/or other suitable components that provide the described functionality. The control system 20 may be distributed among different vehicle modules, such as an infotainment system control module, engine control module or unit, powertrain control module, transmission control module, and the like, if desired.

The term “memory” 52 or “storage” as used herein can include computer readable memory, and may be volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory 52 can store an operating system and/or instructions/programs 54 executable by a processor or controller or the like to enable control or allocate resources of a computing device.

What is claimed is:

1. A method for pairing a vehicle access device to a vehicle, comprising the steps of:
detecting an attempt to pair a vehicle access device with a vehicle;
providing a notification to a user that an attempt to pair the vehicle access device with the vehicle has been detected; and
requesting an authorization from the user before pairing the vehicle access device with the vehicle.

2. The method of claim 1 further comprising:
receiving the authorization; and
completing a pairing process.

3. The method of claim 1 wherein, the attempt to pair the vehicle access device with the vehicle is initiated by a service device that is separate from the vehicle and from the vehicle access device.

4. The method of claim 1 wherein, the attempt to pair the vehicle access device with the vehicle comprises communicating a unique identifier of the vehicle access device to a vehicle control system.

5. The method of claim 1 wherein, the step of providing a notification to the user is accomplished by sending the notification to an external device.

6. The method of claim 5 wherein, the step of providing a notification to the user is accomplished by providing the notification to a vehicle control system for display via an infotainment system of the vehicle.

7. The method of claim 5 wherein, the vehicle control system includes a communication device capable of communicating with the external device and wherein the notification is provided from the communication device.

8. The method of claim 5 wherein, the notification is provided from a vehicle control system to the external device via a remote server.

9. The method of claim 1 wherein, the step of requesting authorization from the user includes prompting the user to input a personal identifier.

10. The method of claim 2 wherein, the step of receiving authorization is done after a user has successfully input a personal identifier.

11. The method of claim 2 wherein, completing the pairing process allows the vehicle access device and a vehicle control system to communicate to permit control of one or more vehicle functions via the vehicle access device.

12. The method of claim 11 wherein, the vehicle access device can perform one or more of the following vehicle functions: operating power door locks, opening windows or doors of the vehicle, disarming or triggering a vehicle alarm system, unlocking or initiating a vehicle ignition system.

13. The method of claim 2 wherein, a cool-down period of a predetermined length begins after the attempt to pair the vehicle access device with the vehicle is detected.

14. The method of claim 13 wherein, the pairing process is completed when authorization has not been received or denied, and the cool-down period has expired, or when authorization is received before the cool-down period has expired.

15. A system for pairing a vehicle access device to a vehicle comprising:
a vehicle control system having a processor, memory and programming arranged to detect an attempt to pair a vehicle access device with the vehicle control system, provide a notification to a user that an attempt to pair the vehicle access device with the vehicle has been detected, and request authorization from the user to permit pairing of the vehicle access device with the vehicle control system.

16. The system of claim 15 wherein the programming is arranged so that the vehicle control system must receive the authorization before the vehicle access device is paired with the vehicle control system.

17. The system of claim 16 wherein the programming is arranged to request a personal identifier be provided from the user before the authorization can be provided to the vehicle control system.

18. The system of claim 15, wherein the programming is arranged so that the vehicle control system must either: 1) receive the authorization before the vehicle access device is paired with the vehicle control system; or 2) allow a cool-down period of time to pass without express authorization being received or denied before the vehicle access device is paired with the vehicle control system.

19. The system of claim 16 wherein, completing the pairing process allows the vehicle access device and a vehicle control system to communicate and the vehicle access device can perform vehicle functions such as operating power door locks, opening windows or doors of the vehicle, disarming or triggering vehicle alarm systems, unlocking or initiating a vehicle ignition system.

20. The system of claim 15 which also includes a remote server and wherein the vehicle control system sends the notification and authorization request to the remote server.
